(19) United States
(12) Patent Application Publication
(10) Pub. No.: US 2026/0072892 A1
(43) Pub. Date: Mar. 12, 2026

(54) DATA PROCESSING APPARATUS, DATA PROCESSING METHOD, AND COMPUTER READABLE MEDIUM

(71) Applicant: Mitsubishi Electric Corporation, Tokyo (JP)

(72) Inventor: Yoshitsugu KAWAMURA, Tokyo (JP)

(73) Assignee: Mitsubishi Electric Corporation, Tokyo (JP)

(21) Appl. No.: 19/389,182

(22) Filed: Nov. 14, 2025

Related U.S. Application Data
(63) Continuation of application No. PCT/JP2023/024990, filed on Jul. 5, 2023.

(51) Int. Cl. G06F 16/22; G06F 16/242

(52) U.S. Cl. CPC G06F 16/2246; G06F 16/244; G06F 2219/10

(57) ABSTRACT

Hierarchical structure data (200) includes: a first hierarchical structure in which first nodes are hierarchized, the first hierarchical structure corresponding to a first analysis axis which is an analysis axis of a GHG emission amount; a second hierarchical structure in which second nodes are hierarchized, the second hierarchical structure corresponding to a second analysis axis which is different from the first analysis axis; and a plurality of emission amount nodes which are nodes of the GHG emission amount. The plurality of first nodes include two or more first connection nodes that connect to an emission amount node, and the plurality of second nodes include two or more second connection nodes that connect to an emission amount node. When one of the first nodes is selected as a first selection node and one of the second nodes is selected as a second selection node, an extraction unit (104) extracts a chain of nodes that leads to the first selection node via the first connection node from the emission amount node to which the first connection node connects, and extracts a chain of nodes that leads to the second selection node via the second connection node from the emission amount node to which the second connection node connects.

### CROSS REFERENCE TO RELATED APPLICATION

This application is a Continuation of PCT International Application No. PCT/JP2023/024990, filed on Jul. 5, 2023, which is hereby expressly incorporated by reference into the present application.

### TECHNICAL FIELD

The present disclosure relates to analysis of greenhouse gas (hereinafter also referred to as GHG) emission amounts.

### BACKGROUND ART

There are technologies disclosed in Patent Literature 1 and Patent Literature 2, as technologies related to analysis of a carbon dioxide (hereinafter also referred to as CO₂) emission amount which is one of the GHG emission amounts.
Patent Literature 1 discloses a method of calculating the CO₂ emission amount of a product from electric power information and fuel information.
Patent Literature 2 discloses a method of calculating the CO₂ emission amount from electric power consumption by service type.

### CITATION LIST

### Patent Literature

Patent Literature 1: JP 2021-189566 A
Patent Literature 2: WO 2010/047170 A1

### SUMMARY OF INVENTION

### Technical Problem

In order to manage the GHG emission amounts and consider possibilities of reducing the GHG emission amounts, it is necessary to visualize breakdown of the GHG emission amounts. It is necessary to visualize the GHG emission amounts for each part of a product, or for each lifecycle (manufacturing, transportation, or the like) of the product, for example.

However, there are numerous analysis axes for the GHG emission amounts, and it is not easy to manage complex data on a large number of analysis axes. An analysis axis for an energy source that generates GHGs may be considered as an analysis axis, for example. Further, an analysis axis for an internal organization of a manufacturer of the product may be considered as another analysis axis. Furthermore, an analysis axis for a part that constitutes the product may be considered as an analysis axis.

The technologies of Patent Literature 1 and Patent Literature 2 do not correspond to such a plurality of analysis axes. Thus, there is a problem that it is not possible to analyze the GHG emission amounts through the plurality of analysis axes.

One of the main objectives of the present disclosure is to solve such problems. Specifically, a main purpose of the present disclosure is to enable analysis of the GHG emission amounts through the plurality of analysis axes.

### Solution to Problem

A data processing apparatus according to present disclosure includes:
a data management unit to manage a hierarchical structure data that includes: a first hierarchical structure in which a plurality of first nodes are hierarchized, the first hierarchical structure corresponding to a first analysis axis which is an analysis axis of a greenhouse gas emission amount; a second hierarchical structure in which a plurality of second nodes are hierarchized, the second hierarchical structure corresponding to a second analysis axis which is an analysis axis of the greenhouse gas emission amount and which is different from the first analysis axis; and a plurality of emission amount nodes which are nodes of the greenhouse gas emission amount, wherein the plurality of first nodes include two or more first connection nodes that connect to one of the emission amount nodes, and the plurality of second nodes include two or more second connection nodes that connect to one of the emission amount nodes; and
an extraction unit, when one of the first nodes is selected as a first selection node and one of the second nodes is selected as a second selection node, to extract for each first connection node, a first node path which is a chain of nodes that leads to the first selection node via the first connection node from the emission amount node to which the first connection node connects, and to extract for each second connection node, a second node path which is a chain of nodes that leads to the second selection node via the second connection node from the emission amount node to which the second connection node connects.

### Advantageous Effects of Invention

According to the present disclosure, it is possible to analyze the GHG emission amounts through the plurality of analysis axes.

### BRIEF DESCRIPTION OF DRAWINGS

FIG. 1 is a diagram illustrating an example of a functional configuration of an emission amount management apparatus according to Embodiment 1.

FIG. 2 is a diagram illustrating an example of hierarchical structure data according to Embodiment 1.

FIG. 3 is a diagram illustrating an example of visualization information according to Embodiment 1.

FIG. 4 is a flowchart illustrating an example of operation of an extraction unit according to Embodiment 1.

FIG. 5 is a diagram illustrating an example of operation in step S1 according to Embodiment 1.

FIG. 6 is a diagram illustrating an example of operation in step S2 according to Embodiment 1.

FIG. 7 is a diagram illustrating an example of operation in step S3 according to Embodiment 1.

FIG. 8 is a diagram illustrating an example of operation in step S4 according to Embodiment 1.

FIG. 9 is a diagram illustrating an example of operation in step S5 according to Embodiment 1.

FIG. 10 is a diagram illustrating an example of operation in step S6 according to Embodiment 1.

FIG. 11 is a diagram illustrating an example of operation in step S7 according to Embodiment 1.

FIG. 12 is a diagram illustrating an example of the hierarchical structure data according to Embodiment 2.

FIG. 13 is a flowchart illustrating an example of operation of the extraction unit according to Embodiment 2.

FIG. 14 is a diagram illustrating an example of operation in step S1 according to Embodiment 2.

FIG. 15 is a diagram illustrating an example of operation in step S11 according to Embodiment 2.

FIG. 16 is a diagram illustrating an example of operation in step S12 according to Embodiment 2.

FIG. 17 is a diagram illustrating an example of operation in step S13 according to Embodiment 2.

FIG. 18 is a diagram illustrating an example of a hardware configuration of the emission amount management apparatus according to Embodiment 1.

### DESCRIPTION OF EMBODIMENTS

Embodiments will be described hereinafter with reference to the drawings. In the following description of the embodiments and the drawings, portions denoted by the same reference signs indicate the same or corresponding portions.

In the following, CO₂ will be described as an example of a GHG. CO₂ is just one example of the GHG, and the description below can also be applied to GHGs (methane, nitrous oxide, fluorocarbons, and the like) other than CO₂.

### Embodiment 1

### ***Description of Configuration***

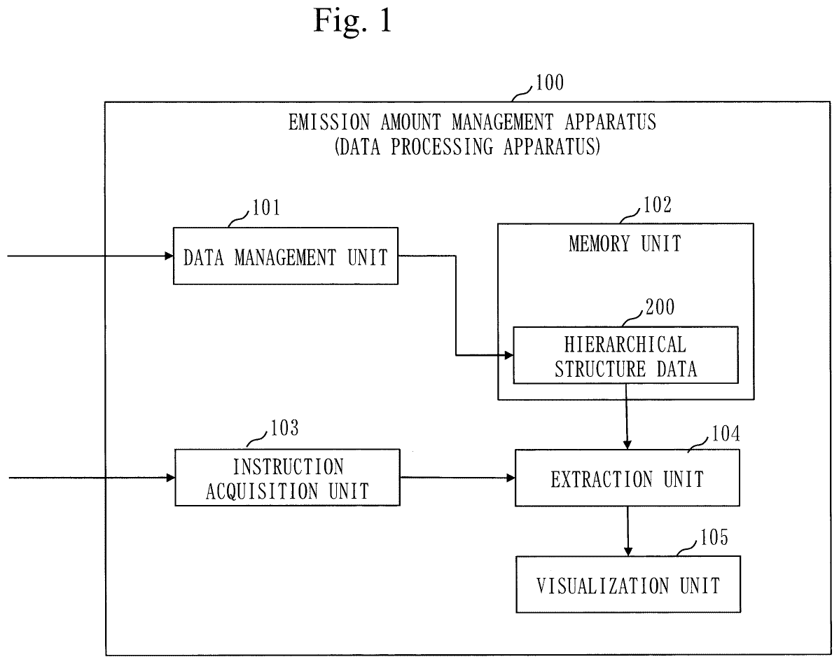

FIG. 1 illustrates an example of a functional configuration of an emission amount management apparatus 100 according to the present embodiment.

The emission amount management apparatus 100 is equivalent to a data processing apparatus. Further, an operation procedure of the emission amount management apparatus 100 is equivalent to a data processing method. Further, a program that implements operation of the emission amount management apparatus 100 is equivalent to a data processing program.

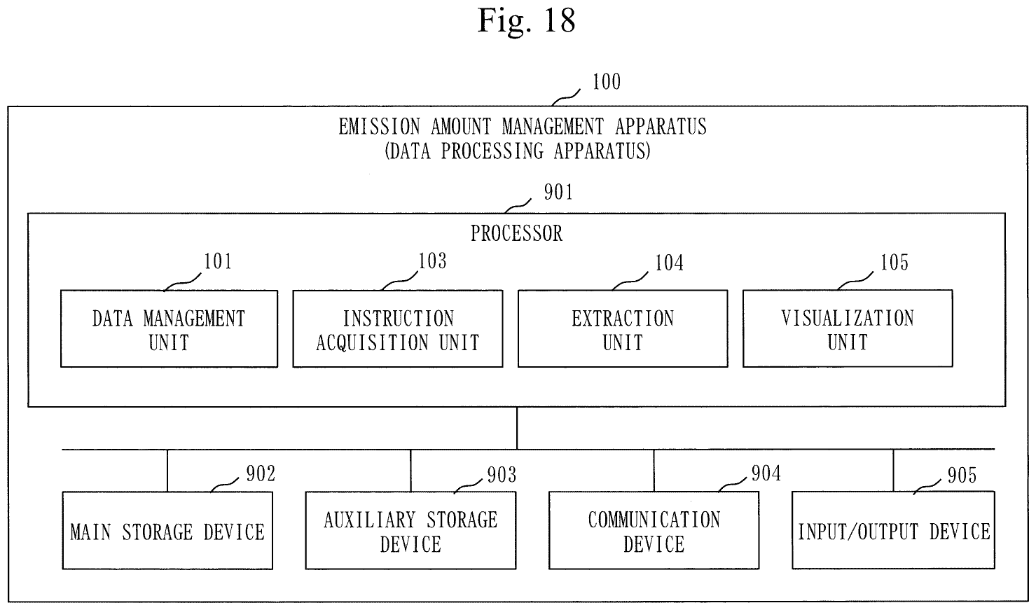

FIG. 18 illustrates an example of a hardware configuration of the emission amount management apparatus 100 according to the present embodiment.

First, the hardware configuration of the emission amount management apparatus 100 will be described with reference to FIG. 18.

The emission amount management apparatus 100 according to the present embodiment is a computer.

The emission amount management apparatus 100 includes a processor 901, a main memory device 902, an auxiliary storage device 903, a communication device 904, and an input/output device 905, as pieces of hardware.

The emission amount management apparatus 100 includes, as illustrated in FIG. 1, a memory unit 102, an instruction acquisition unit 103, an extraction unit 104 and a visualization unit 105, as functional components. The functions of the instruction acquisition unit 103, the extraction unit 104, and the visualization unit 105 are implemented by, for example, programs.

The auxiliary storage device 903 stores the programs that implement the functions of the instruction acquisition unit 103, the extraction unit 104, and the visualization unit 105.

These programs are loaded from the auxiliary storage device 903 to the main memory device 902. Then, the processor 901 executes these programs, and performs operation of the instruction acquisition unit 103, the extraction unit 104, and the visualization unit 105 to be described below.

FIG. 18 schematically illustrates a state in which the processor 901 executes the programs that implement the functions of the instruction acquisition unit 103, the extraction unit 104, and the visualization unit 105.

The memory unit 102 is implemented by the main memory device 902 and/or the auxiliary storage device 903.

The communication device 904 performs communication with an external device.

The input/output device 905 is, for example, a mouse, a keyboard, or a display.

Next, the example of the functional configuration of the emission amount management apparatus 100 will be described with reference to FIG. 1.

A data management unit 101 manages hierarchical structure data 200.

Specifically, the data management unit 101 obtains configuration information that indicates a configuration of the hierarchical structure data 200. Then, the data management unit 101 generates the hierarchical structure data 200, using the obtained configuration information. Further, the data management unit 101 stores the generated hierarchical structure data 200 in the memory unit 102.

The data management unit 101 obtains from a data analyst who is a user of the emission amount management apparatus 100, the configuration information via the mouse and the keyboard of the input/output device 905, for example. Further, the data management unit 101 obtains (receives) the configuration information transmitted from an external device via a network through the communication device 904, for example. The data management unit 101 may obtain the generated hierarchical structure data 200 from an external device.

The hierarchical structure data 200 is data that includes a hierarchical structure and is used for analysis of a CO₂ emission amount. The hierarchical structure data 200 includes a first hierarchical structure, a second hierarchical structure, and an emission amount node. The first hierarchical structure is a hierarchical structure corresponding to a first analysis axis which is an analysis axis of the CO₂ emission amount. The second hierarchical structure is a hierarchical structure corresponding to a second analysis axis which is an analysis axis of the CO₂ emission amount and which is different from the first analysis axis.

In each of the first hierarchical structure and the second hierarchical structure, a plurality of nodes are hierarchized. A node included in the first hierarchical structure is referred to as a first node. Further, a node included in the second hierarchical structure is referred to as a second node.

The emission amount node is a node of the CO₂ emission amount.

The details of the hierarchical structure data 200 will be described below. Further, the details of the configuration information will be described below along with the details of the hierarchical structure data 200.

A process performed by the data management unit 101 is equivalent to a data management process.

The memory unit 102 stores the hierarchical structure data 200.

The instruction acquisition unit 103 acquires an analysis instruction from the data analyst via the mouse and the keyboard of the input/output device 905.

The analysis instruction is a command that instructs to analyze the CO₂ emission amount. In the analysis instruction, a condition for extracting a node path from the hierarchical structure data 200 is specified. The node path is a chain of nodes. The details of the node path will be described below.

The extraction unit 104 extracts from the hierarchical structure data 200, the node path corresponding to the condition specified in the analysis instruction.

A process performed by the extraction unit 104 is equivalent to an extraction process.

The visualization unit 105 generates visualization information that visualizes the CO₂ emission amount based on the first analysis axis and the second analysis axis, using the node path extracted by the extraction unit 104.

The visualization unit 105 generates, for example, a sankey diagram, as the visualization information.

Then, the visualization unit 105 outputs the visualization information to the display of the input/output device 905.

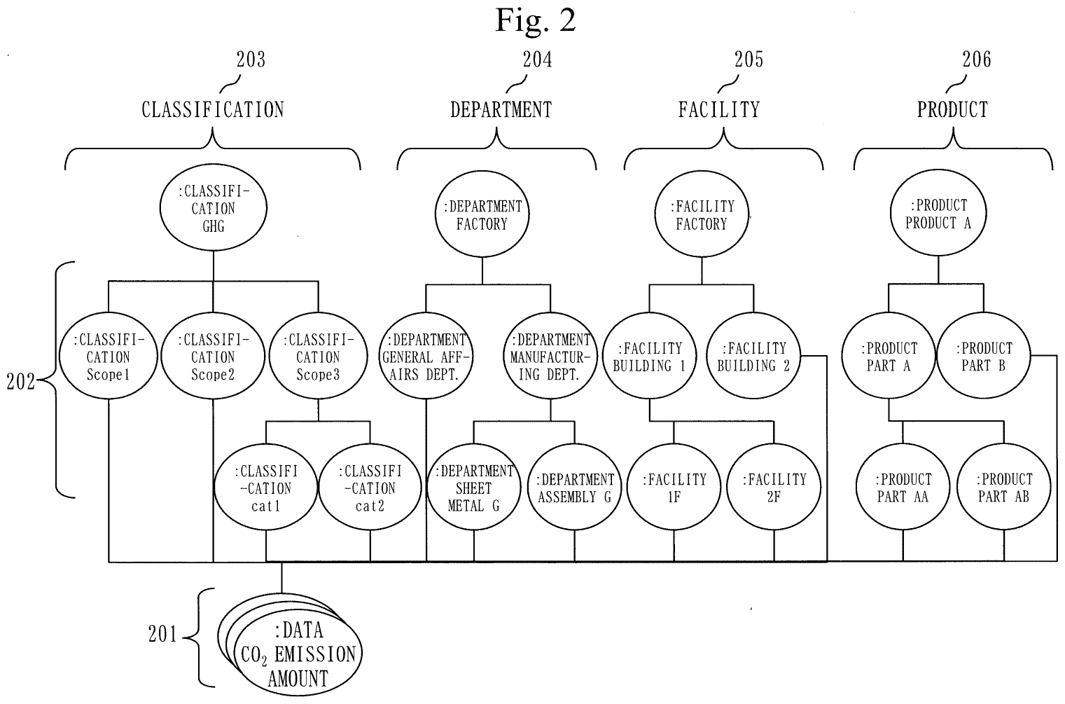

FIG. 2 illustrates an example of the hierarchical structure data 200.

The hierarchical structure data 200 is data that has a data structure in graph format. In graph format, data is represented by nodes and edges. In FIG. 2, a node is represented by a circle. Further, in FIG. 2, an edge is represented by a line that connects two nodes.

A graph database is considered for use as a database to hold data in graph format. Alternatively, a relational database, a key-value database, a document database, or the like may be used as the database to hold data in graph format.

A CO₂ emission amount node 201 is an emission amount node.

The CO₂ emission amount node 201 is a data node at which the CO₂ emission amount which is a GHG emission amount is set. The hierarchical structure data 200 includes a plurality of CO₂ emission amount nodes 201.

The CO₂ emission amount is represented by a numerical value such as weight (kg), volume (m³), or the like.

Further, the CO₂ emission amount node 201 may have a value set for calculating the CO₂ emission amount instead of the CO₂ emission amount. A value that is the base of calculating the CO₂ emission amount, such as an electric power consumption, heat amount, or water amount, may be set to the CO₂ emission amount node 201, for example. In this case, the extraction unit 104 calculates the CO₂ emission amount by applying a conversion formula to the value set in the CO₂ emission amount node 201. Further, the extraction unit 104 may transfer the value set in the CO₂ emission amount node 201 (the value that is the base of calculating the CO₂ emission amount) to the visualization unit 105 without calculating the CO₂ emission amount, and the visualization unit 105 may visualize the value of the CO₂ emission amount node 201.

Further, the CO₂ emission amount node 201 at which the CO₂ emission amount is set and the CO₂ emission amount node 201 at which the value for calculating the CO₂ emission amount is set may coexist.

In the following, in order to simplify the description, it is assumed that the hierarchical structure data 200 only includes the CO₂ emission amount node 201 at which the CO₂ emission amount is set.

The tag data 202 is data that has a hierarchical structure. The number of layers illustrated in FIG. 2 is as an example, and the tag data 202 may have a hierarchical structure with the number of layers other than those illustrated in FIG. 2.

The tag data 202 includes, for example, classification tag data 203, department tag data 204, facility tag data 205, product tag data 206, or the like. In addition to these, a tag node that represents a year, month and day may be included in the hierarchical structure data 200.

A node included in the tag data 202 is referred to as a tag node. The tag node is hereinafter simply referred to as a node. A plurality of tag nodes are included in each tag data 202, and the plurality of tag nodes are hierarchized.

Two or more tag nodes among the plurality of tag nodes are connected to (associated with) the CO₂ emission amount node 201. A tag node connected to the CO₂ emission amount node 201 is referred to as a connection node.

In the present embodiment, a tag node at the lowest layer of the hierarchical structure is connected to the CO₂ emission amount node 201.

A tag node at a layer other than the lowest layer may be connected to the CO₂ emission amount node 201. That is, the connection node may be a tag node at a layer other than the lowest layer.

The CO₂ emission amount node 201 is connected to two or more connection nodes of two or more hierarchical structures.

The CO₂ emission amount node 201 may be connected to a tag node of “Scope1”, a tag node of “assembly G”, a tag node of “1F”, and a tag node of “part AA”, for example. This case means that the CO₂ emission amount of the CO₂ emission amount node 201 is the CO₂ emission amount which is related to “part AA”, is emitted by a facility that is located in “1F” of “assembly G”, and belongs to “Scope1”.

The classification tag data 203 is tag data corresponding to the GHG protocol. The GHG protocol is an international standard for calculating and reporting the GHG emission amount.

The tag node of “Scope1”, a tag node of “Scope2”, and a tag node of “Scope3” are provided as subordinate tag nodes of a tag node of “GHG” at the highest layer.

The tag node of “Scope1” is a tag node corresponding to “Scope1 (direct emission amount)” of the GHG protocol. The tag node of “Scope2” is a tag node corresponding to “Scope2 (indirect emission amount)” of the GHG protocol. The tag node of “Scope3” is a tag node corresponding to “Scope3 (another emission amount)” of the GHG protocol.

In the example of FIG. 2, a tag node of “category 1” and a tag node of “category 2” are provided below the tag node of “Scope3”. The tag node of “category 1” is a tag node corresponding to “category 1” of the GHG protocol. The tag node of “category 2” is a tag node corresponding to “category 2” the GHG protocol. In the drawing, “category 1” and “category 2” are written as “cat1” and “cat2”.

The GHG protocol defines 15 categories as categories of “Scope3”. In the present embodiment, only the tag node of “category 1” and the tag node of “category 2” are provided, however 15 tag nodes corresponding to the 15 categories of the GHG protocol may be provided below the tag node of “Scope3”.

In the classification tag data 203, each of the tag node of “Scope1”, the tag node of “Scope2”, the tag node of “category 1” and the tag node of “category 2” of the tag node of “Scope3” is connected to the CO₂ emission amount node 201.

Further, the classification tag data 203 is equivalent to the first hierarchical structure corresponding to the first analysis axis.

Thus, each tag node included in the classification tag data 203 is equivalent to the first node.

Further, a tag node that connects to the CO₂ emission amount node 201 is equivalent to a first connection node. Specifically, each of the tag node of “Scope1”, the tag node of “Scope2”, the tag node of “category 1”, and the tag node of “category 2” is equivalent to the first connection node.

Tag data other than the classification tag data 203 may be used as the first hierarchical structure. Tag data corresponding to an energy source that generates CO₂ may be used as the first hierarchical structure, for example. In this case, tag nodes corresponding to individual energy sources (coal, coke, natural gas, biomass, and the like) are set in the hierarchical structure.

Further, instead of the classification tag data 203, one of the department tag data 204, the facility tag data 205, and the product tag data 206 may be treated as the first hierarchical structure.

Further, there may be a plurality of pieces of tag data that are treated as the first hierarchical structure.

The department tag data 204 is tag data that represents a department. The department is an emission source of CO₂.

Specifically, in the department tag data 204, the emission source of CO₂ is a factory.

A tag node of “general affairs department” and a tag node of “manufacturing department” are provided as subordinate tag nodes of a tag node of “factory” at the highest layer. The tag node of “general affairs department” is a tag node corresponding to “general affairs department” which is an organization in the factory. The tag node of “manufacturing department” is a tag node corresponding to “manufacturing department” which is another organization in the factory.

Further, a tag node of “sheet metal G” and a tag node of “assembly G” are provided as subordinate tag nodes of the tag node of “manufacturing department”. The tag node of “sheet metal G” is a tag node corresponding to a sheet metal group in the manufacturing department. The tag node of “assembly G” is a tag node corresponding to an assembly group in the manufacturing department.

Each of the tag node of “general affairs department”, the tag node of “sheet metal G”, and the tag node of “assembly G” stores a department Identifier (ID), department name, affiliated staff, number of people, location, telephone number, and the like.

In the department tag data 204, each of the tag node of “general affairs department”, the tag node of “sheet metal G”, and the tag node of “assembly G” is connected to the CO₂ emission amount node 201. That is, each of the tag node of “general affairs department”, the tag node of “sheet metal G”, and the tag node of “assembly G” is the connection node.

The facility tag data 205 is data that represents the facility. The facility is an emission source of CO₂.

Specifically, in the facility tag data 205, the emission source of CO₂ is the factory.

A tag node of “building 1” and a tag node of “building 2” are provided as subordinate tag nodes of a tag node of “factory” at the highest layer. The tag node of “building 1” is a tag node corresponding to “building 1” which is a building in the factory. The tag node of “building 2” is a tag node corresponding “building 2” which is another building in the factory.

Further, a tag node of “1F” and a tag node of “2F” are provided as subordinate tag nodes of the tag node of “building 1”. The tag node of “1F” is a tag node corresponding to the first floor of the building 1. The tag node of “2F” is a tag node corresponding to the second floor of the building 1.

Each of the tag node of “1F”, the tag node of “2F”, and the tag node of “building 2” stores a facility ID, facility name, size, and the like.

In the facility tag data 205, each of the tag node of “1F”, the tag node of “2F”, and the tag node of “building 2” is connected to the CO₂ emission amount node 201. That is, each of the tag node of “1F”, the tag node of “2F”, and the tag node of “building 2” tag node is the connection node.

The product tag data 206 is data that represents a product. The product is a physical item that is manufactured in the factory which is an emission source of CO₂.

A tag node of “part A” and a tag node of “part B” are provided as subordinate tag nodes of a tag node of “product” at the highest layer. The tag node of “part A” is a tag node corresponding to “part A” which is a component of the product. The tag node of “part B” is a tag node corresponding to “part B” which is another component of the product.

Further, a tag node of “part AA” and a tag node of “part AB” are provided as subordinate tag nodes of the tag node of “part A”. The tag node of “part AA” is a tag node corresponding to “part AA” which is a component of the part A. The tag node of “part AB” is a tag node corresponding to “part AB” which is another component of the part A.

Each of the tag node of “part B”, the tag node of “part AA”, and the tag node of “part AB” stores a part ID, part name, model number, cost, weight, and the like.

In the product tag data 206, each of the tag node of “part B”, the tag node of “part AA”, and the tag node of “part AB” is connected to the CO₂ emission amount node 201. That is, each of the tag node of “part B”, the tag node of “part AA”, and the tag node of “part AB” is the connection node.

Each of the department tag data 204, the facility tag data 205, and the product tag data 206 is equivalent to the second hierarchical structure corresponding to the second analysis axis.

Thus, each tag node included in the department tag data 204, the facility tag data 205, and the product tag data 206 is equivalent to the second node.

Further, a tag node that connects to the CO₂ emission amount node 201 in the department tag data 204, the facility tag data 205, and the product tag data 206 is equivalent to a second connection node.

Specifically, in the department tag data 204, each of the tag node of “general affairs department”, the tag node of “sheet metal G” and the tag node of “assembly G” is equivalent to the second connection node.

Further, in the facility tag data 205, each of the tag node of “1F”, the tag node of “2F”, and the tag node of “building 2” is equivalent to the second connection node. Further, in the product tag data 206, each of the tag node of “part B”, the tag node of “part AA”, and the tag node of “part AB” is equivalent to the second connection node.

Tag data other than the department tag data 204, the facility tag data 205, and the product tag data 206 may also be used as the second hierarchical structure.

In the following, a tag node of “XX” may be simply written as “XX”. That is, the tag node of “GHG” may be simply written as “GHG”, or the tag node of “factory” may be simply written as “factory”, for example.

The data management unit 101 illustrated in FIG. 1 obtains the configuration information that describes the configuration of the hierarchical structure data 200 illustrated in FIG. 2.

Each CO₂ emission amount node 201 is described in the configuration information obtained by the data management unit 101. Further, details of the classification tag data 203 are described in the configuration information. A tag node included in the classification tag data 203, a relation between tag nodes, a connection node of the classification tag data 203, and the CO₂ emission amount node 201 to which the connection node of the classification tag data 203 connects are described in the configuration information, for example. Further, as with the classification tag data 203, details of each of the department tag data 204, the facility tag data 205, and the product tag data 206 are described in the configuration information.

Further, when the CO₂ emission amount node 201 is used to which a value for calculating the CO₂ emission amount, such as electric power consumption, heat amount, water amount, or the like is set, the configuration information includes a conversion formula.

The data management unit 101 can obtain the configuration information in a format such as, for example, a csv file, xml (registered trademark) file, binary file, database operation query, or the like.

The data management unit 101 generates the hierarchical structure data 200 exemplified in FIG. 2, using the obtained configuration information, and stores the generated hierarchical structure data 200 in the memory unit 102.

The data analyst uses the mouse and the keyboard of the input/output device 905 to input the analysis instruction to the instruction acquisition unit 103.

The data analyst selects one of the nodes of the classification tag data 203 as a first selection node, for example.

When there are a plurality of pieces of tag data corresponding to the first analysis axis, the data analyst selects one of the pieces of tag data from among the plurality of pieces of tag data as a first selection hierarchical structure. Further, the data analyst selects one of the nodes in the tag data selected as the first selection hierarchical structure as the first selection node.

Further, the data analyst selects one of the department tag data 204, the facility tag data 205, and the product tag data 206 as a second selection hierarchical structure. Further, the data analyst selects one of the nodes in the tag data selected as the second selection hierarchical structure as a second selection node.

The data analyst can select a plurality of first selection nodes, and can select a plurality of second selection nodes. Then, the data analyst inputs the analysis instruction that indicates a selection result into the instruction acquisition unit 103.

Further, the data analyst may specify a period. The data analyst can specify the period in a unit such as a single year, plurality of years, single month, plurality of months, day, or week.

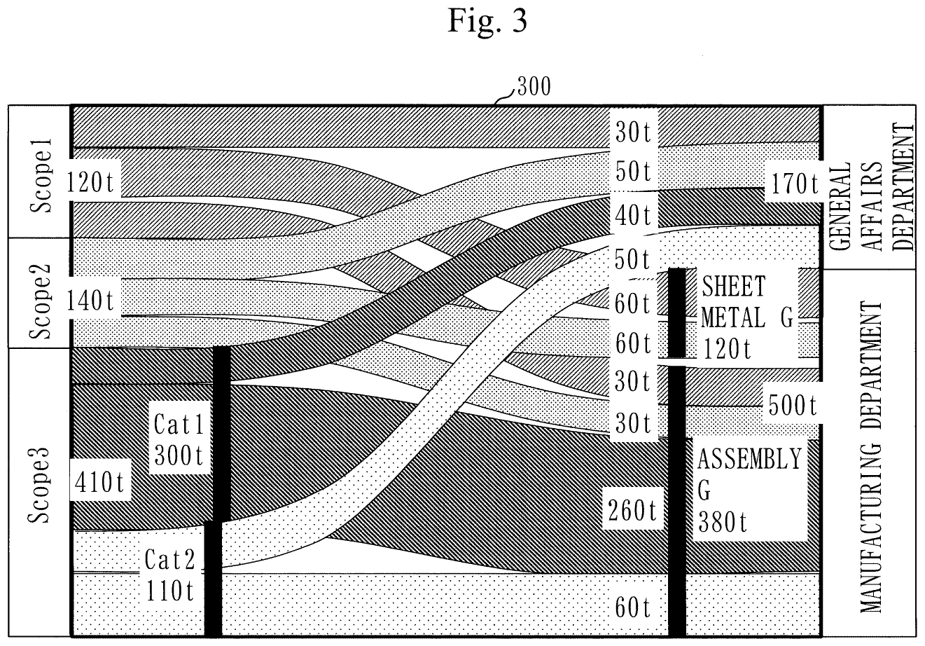

FIG. 3 illustrates an example of the visualization information 300 that the visualization unit 105 outputs to the input/output device 905.

FIG. 3 illustrates an example of the visualization information 300 represented by the sankey diagram.

In the visualization information 300 represented by the sankey diagram, the thickness of a line is proportional to the size of the CO₂ emission amount.

The visualization information 300 indicates an extraction result of the CO₂ emission amount corresponding to conditions (the first selection hierarchical structure, the first selection node, the second selection hierarchical structure, the second selection node) instructed by the data analyst in the analysis instruction.

FIG. 3 illustrates the visualization information 300 when each of the tag nodes of “Scope1”, “Scope2”, “category 1”, and “category 2” in the classification tag data 203 of FIG. 2 is selected as the first selection node, and each of the tag nodes of “general affairs department”, “sheet metal G”, and “assembly G” in the department tag data 204 of FIG. 2 is selected as the second selection node.

The first selection nodes and the superordinate node of the first selection nodes are indicated on the left end of the visualization information 300. That is, “Scope1” and “Scope2” which are the first selection nodes, and “Scope3” which is the superordinate node of “category 1” and “category 2” which are the first selection nodes are indicated on the left end of the visualization information 300. Further, the second selection node and the superordinate node of the second selection node are indicated on the right end of the visualization information 300. That is, “general affairs department” which is the second selection node and “manufacturing department” which is the superordinate node of “sheet metal G” and “assembly G” which are the second selection nodes are indicated on the right end of the visualization information 300.

Further, the CO₂ emission amount corresponding to each of “Scope1”, “Scope2”, and “Scope3” is shown near the left end of the visualization information 300. Further, the CO₂ emission amount corresponding to each of “category 1” and “category 2” of “Scope3” is also shown in the visualization information 300. Further, the CO₂ emission amount corresponding to each of “general affairs department” and “manufacturing department” is shown near the right end of the visualization information 300. The CO₂ emission amount corresponding to each of “sheet metal G” and “assembly G” of “manufacturing department” is also shown in the visualization information 300.

Further, the CO₂ emission amount for a combination of the first selection node and the second selection node is also shown. “30t” at the highest level is the CO₂ emission amount for the combination of “Scope1” and “general affairs department”. The next “50t” is the CO₂ emission amount for the combination of “Scope2” and “general affairs department”. The next “40t” is the CO₂ emission amount for the combination of “category 1” and “general affairs department”. The next “50t” is the CO₂ emission amount for the combination of “category 2” and “general affairs department”. The CO₂ emission amounts for “sheet metal G” and “assembly G” are shown in the same format as that of “general affairs department”.

The data analyst can efficiently formulate measures to reduce the CO₂ emission amount by referring to the visualization information. In FIG. 3, the line corresponding to the combination of “category 1” and “assembly G” is thick. Thus, the data analyst can recognize that it is necessary to formulate measures for this combination.

The visualization unit 105 may generate the visualization information by a bar graph, stacked bar graph, pie chart, or the like, instead of the sankey diagram.

### ***Description of Operation**

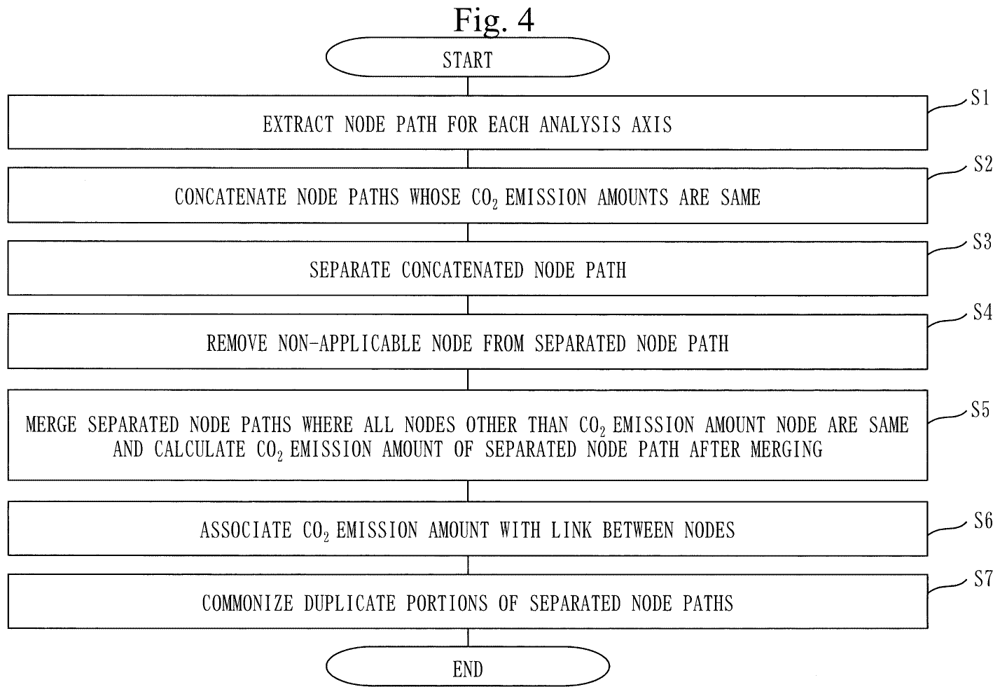

FIG. 4 illustrates an example of operation of the extraction unit 104 according to the present embodiment.

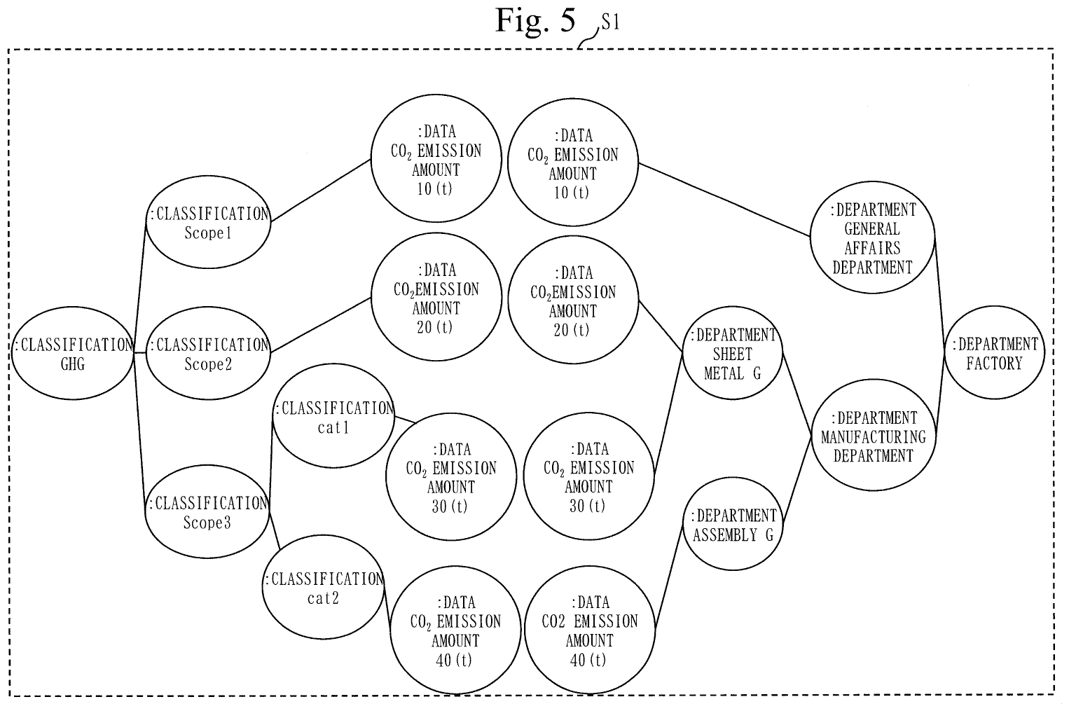

FIG. 5 illustrates a specific example of step S1 in FIG. 4.

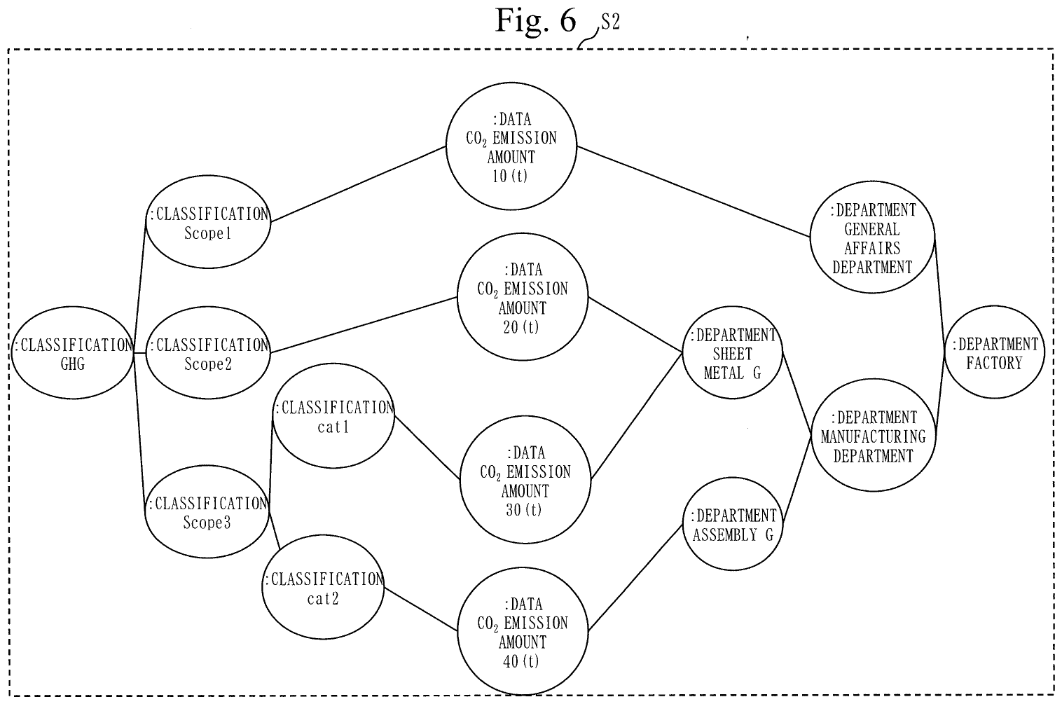

FIG. 6 illustrates a specific example of step S2 in FIG. 4.

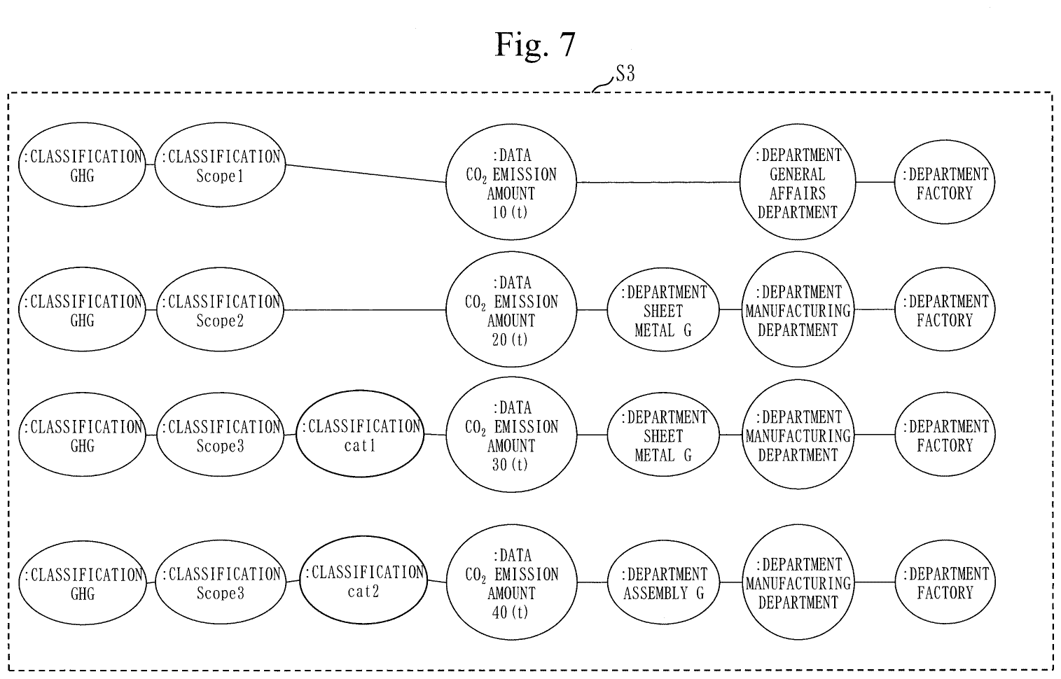

FIG. 7 illustrates a specific example of step S3 in FIG. 4.

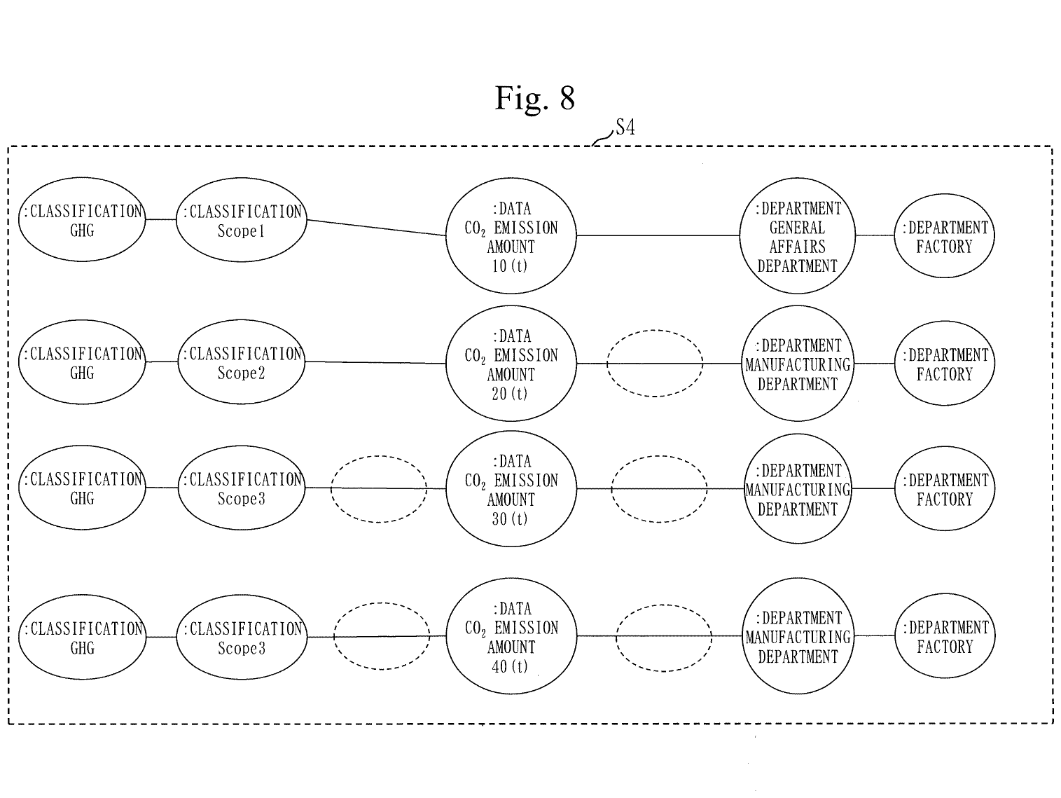

FIG. 8 illustrates a specific example of step S4 in FIG. 4.

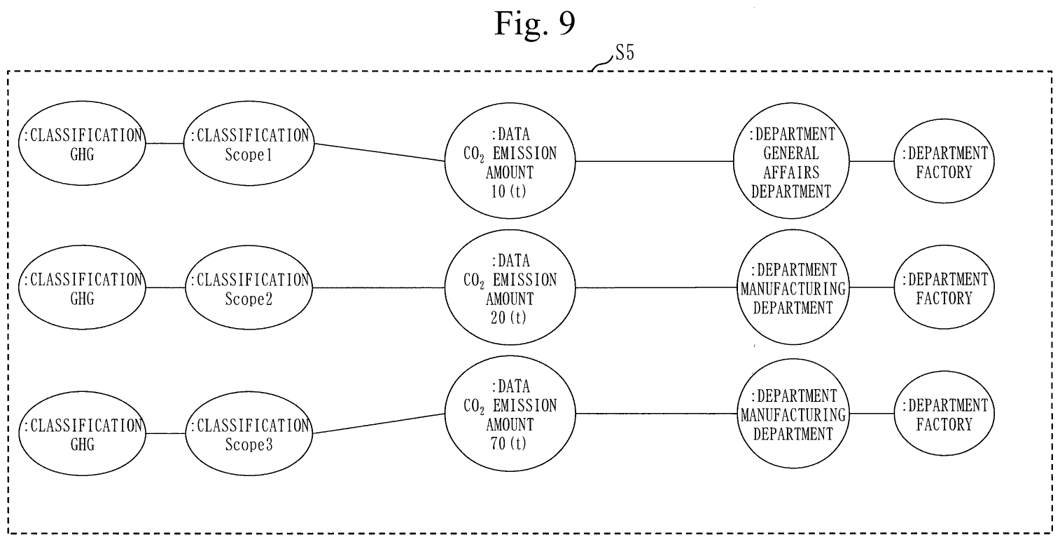

FIG. 9 illustrates a specific example of step S5 in FIG. 4.

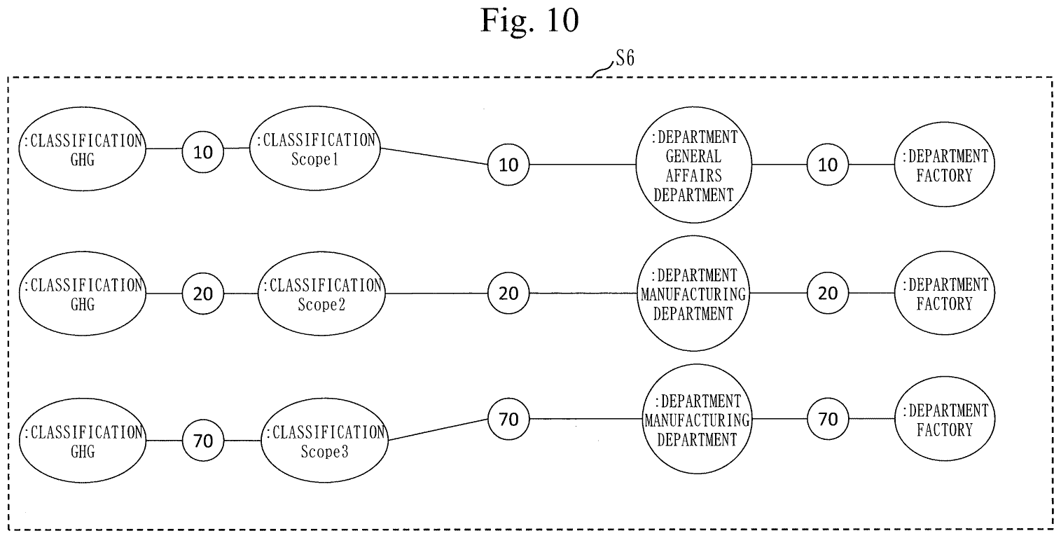

FIG. 10 illustrates a specific example of step S6 in FIG. 4.

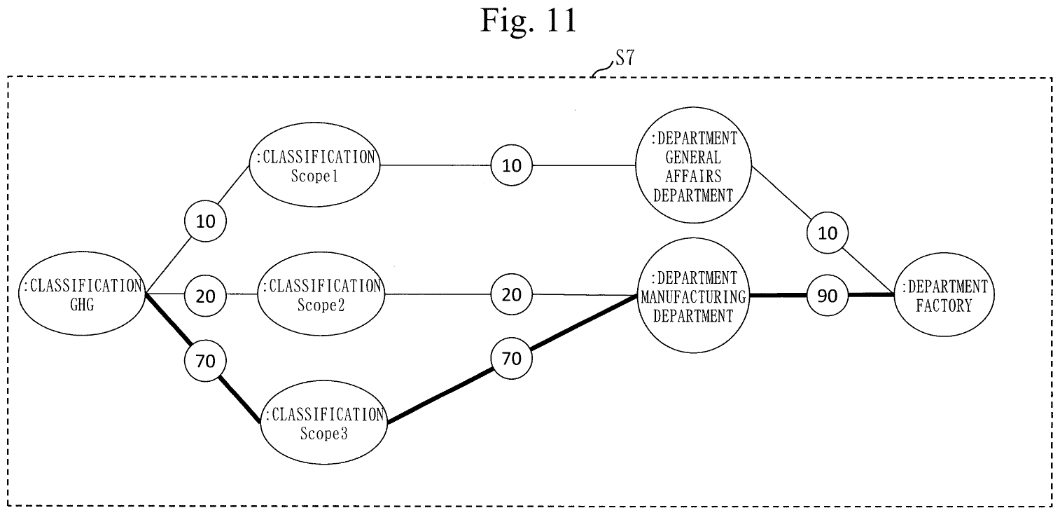

FIG. 11 illustrates a specific example of step S7 in FIG. 4.

In the following, the example of the operation of the extraction unit 104 will be described with reference to FIGS. 4 to 10.

First, in step S1 in FIG. 4, the extraction unit 104 extracts a node path from the hierarchical structure data 200 for each analysis axis according to the analysis instruction.

When a condition such as a period (year, month, day) is specified in the analysis instruction, the data management unit 101 extracts only a node path that conforms to the condition.

The node path is a chain of nodes that leads to a selection node via a connection node from the CO₂ emission amount node 201 to which the connection node connects. The selection node is a node selected by the data analyst through the analysis instruction.

The extraction unit 104 extracts the node path for each of the first analysis axis and the second analysis axis, for each connection node.

In the first analysis axis, the chain of nodes that leads to the selection node (the first selection node) via the connection node (the first connection node) from the CO₂ emission amount node 201 to which the connection node (the first connection node) connects is referred to as a first node path. Further, in the second analysis axis, the chain of nodes that leads to the selection node (the second selection node) via the connection node (the second connection node) from the CO₂ emission amount node 201 to which the connection node (the second connection node) connects is referred to as a second node path.

Details of step S1 will be described with reference to FIG. 5.

In the following, it is assumed that in the analysis instruction, “GHG”, “Scope1”, “Scope2”, and “Scope3” of the classification tag data 203 in FIG. 2 have been selected as the first selection nodes. Further, in the analysis instruction, it is assumed that “factory”, “general affairs department”, and “manufacturing department” of the department tag data 204 in FIG. 2 have been selected as the second selection nodes.

In the classification tag data 203 corresponding to the first analysis axis, “Scope1”, “Scope2”, “category 1”, and “category 2” are the first connection nodes.

The extraction unit 104 extracts “CO₂ emission amount 10(t)” which is the CO₂ emission amount node 201 to which “Scope1” which is the first connection node connects. Then, the extraction unit 104 extracts a node path that leads from “CO₂ emission amount 10(t)” to “GHG” which is the first selection node via “Scope1” which is the first connection node, as the first node path.

Further, the extraction unit 104 extracts “CO₂ emission amount 20(t)” which is the CO₂ emission amount node 201 to which “Scope2” which is the first connection node connects. Then, the extraction unit 104 extracts a node path that leads from “CO₂ emission amount 20(t)” to “GHG” which is the first selection node via “Scope2” which is the first connection node, as the first node path.

Furthermore, the extraction unit 104 extracts “CO₂ emission amount 30(t)” which is the CO₂ emission amount node 201 to which “category 1” which is the first connection node connects. Then, the extraction unit 104 extracts a node path that leads from “CO₂ emission amount 30(t)” to “GHG” which is the first selection node via “category 1” which is the first connection node, as the first node path.

Furthermore, the extraction unit 104 extracts “CO₂ emission amount 40(t)” which is the CO₂ emission amount node 201 to which “category 2” which is the first connection node connects. Then, the extraction unit 104 extracts a node path that leads from “CO₂ emission amount 40(t)” to “GHG” which is the first selection node via “category 2” which is the first connection node, as the first node path.

In the department tag data 204 corresponding to the second analysis axis, “general affairs department”, “sheet metal G”, and “assembly G” are the second connection nodes.

The extraction unit 104 extracts “CO₂ emission amount 10(t)” which is the CO₂ emission amount node 201 to which “general affairs department” which is the second connection node connects. Then, the extraction unit 104 extracts a node path that leads from “CO₂ emission amount 10(t)” to “factory” which is the second selection node via “general affairs department” which is the second connection node, as the second node path.

Further, the extraction unit 104 extracts “CO₂ emission amount 20(t)” and “CO₂ emission amount 30(t)” which are the CO₂ emission amount nodes 201 to which “sheet metal G” which is the second connection node connects. Then, the extraction unit 104 extracts a node path that leads from “CO₂ emission amount 20(t)” to “factory” which is the second selection node via “sheet metal G” which is the second connection node, as the second node path. Furthermore, the extraction unit 104 extracts a node path that leads from “CO₂ emission amount 30(t)” to “factory” which is the second selection node via “sheet metal G” which is the second connection node, as the second node path.

Further, the extraction unit 104 extracts “CO₂ emission amount 40(t)” which is the CO₂ emission amount node 201 to which “assembly G” which is the second connection node connects. Then, the extraction unit 104 extracts a node path that leads from “CO₂ emission amount 40(t)” to “factory” which is the second selection node via “assembly G” which is the second connection node, as the second node path.

Further, the extraction unit 104 manages the plurality of extracted first node paths in a tree structure in which duplicate portions are commonized.

Furthermore, the extraction unit 104 manages the plurality of extracted second node paths in a tree structure in which duplicate portions are commonized.

FIG. 5 illustrates a result of the process of step S1.

In FIG. 5, the first analysis axis is illustrated on the left, and the second analysis axis is illustrated on the right. Further, in FIG. 5, the tag nodes on the layer at the highest level are illustrated on the outer side.

Further, as described above, in FIG. 5, the plurality of extracted first node paths and the plurality of extracted second node paths are managed in tree structures.

Specifically, in the first analysis axis, “GHG” is duplicated in the plurality of first node paths. Thus, in FIG. 5, “GHG” is commonized. Further, in the node path of “category 1” and the node path of “category 2”, “Scope3” is duplicated. Thus, in FIG. 5, “Scope3” is commonized.

Similarly, in the second analysis axis, “factory” is duplicated in the plurality of second node paths. Thus, in FIG. 5, “factory” is commonized. Further, in the node path of “CO₂ emission amount 20(t)” and the node path of “CO₂ emission amount 30(t)”, “sheet metal G” is duplicated. Thus, in FIG. 5, “sheet metal G” is commonized. Further, in the node path of “sheet metal G” and the node path of “assembly G”, “manufacturing department” is duplicated. Thus, in FIG. 5, “manufacturing department” is commonized.

Next, in step S2 in FIG. 4, the extraction unit 104 concatenates the first node path and the second node path whose CO₂ emission amount nodes 201 are the same. In the following, a node path after concatenation is referred to as a concatenated node path.

In the example of FIG. 5, “CO₂ emission amount 10(t)” connected to “Scope1” and “CO₂ emission amount 10(t)” connected to “general affairs department” are the same. Thus, the extraction unit 104 concatenates the node path of “Scope1” and the node path of “general affairs department”. At this time, the extraction unit 104 removes “CO₂ emission amount 10(t)” from one of the node paths.

Further, “CO₂ emission amount 20(t)” connected to “Scope2” and “CO₂ emission amount 20(t)” connected to “sheet metal G” are the same. Thus, the extraction unit 104 concatenates the node path of “Scope2” and the node path of “sheet metal G”. At this time, the extraction unit 104 removes “CO₂ emission amount 20(t)” from one of the node paths.

Further, “CO₂ emission amount 30(t)” connected to “category 1” and “CO₂ emission amount 30(t)” connected to “sheet metal G” are the same. Thus, the extraction unit 104 concatenates the node path of “category 1” and the node path of “sheet metal G”. At this time, the extraction unit 104 removes “CO₂ emission amount 30(t)” from one of the node paths.

Further, “CO₂ emission amount 40(t)” connected to “category 2” and “CO₂ emission amount 40(t)” connected to “assembly G” are the same. Thus, the extraction unit 104 concatenates the node path of “category 2” and the node path of “assembly G”. At this time, the extraction unit 104 removes “CO₂ emission amount 40(t)” from one of the node paths.

FIG. 6 illustrates a result of the process of step S2.

In FIG. 6, a chain (hereinafter referred to as a chain 1) of nodes is generated that leads from “GHG” to “factory” via “Scope1”, “CO₂ emission amount 10(t)”, and “general affairs department”.

Further, in FIG. 6, a chain (hereinafter referred to as a chain 2) of nodes is generated that leads from “GHG” to “factory” via “Scope2”, “CO₂ emission amount 20(t)”, “sheet metal G”, and “manufacturing department”.

Further, in FIG. 6, a chain (hereinafter referred to as a chain 3) of nodes is generated that leads from “GHG” to “factory” via “Scope3”, “category 1”, “CO₂ emission amount 30(t)”, “sheet metal G”, and “manufacturing department”.

Further, in FIG. 6, a chain (hereinafter referred to as a chain 4) of nodes is generated that leads from “GHG” to “factory” via “Scope3”, “category 2”, “CO₂ emission amount 40(t)”, “assembly G”, and “manufacturing department”.

Next, in step S3 in FIG. 4, the extraction unit 104 separates the concatenated node path.

Specifically, the extraction unit 104 separates the concatenated node path into a plurality of node paths to satisfy the following two conditions.

(1) Each of the plurality of chains of nodes included in the concatenated node path is included in one of the plurality of node paths after separation.

(2) The chains of nodes included in each of the plurality of node paths after separation are mutually different.

As described above, the concatenated node path illustrated in FIG. 6 includes four chains of nodes which are the chains 1 to 4.

In step S3, The extraction unit 104 separates the concatenated node path illustrated in FIG. 6 into a node path corresponding to the chain 1, a node path corresponding to the chain 2, a node path corresponding to the chain 3, and a node path corresponding to the chain 4.

As a result, four node paths illustrated in FIG. 7 are obtained.

Each of a plurality of node paths (a plurality of node paths illustrated in FIG. 7) obtained by separation in step S3 is referred to as a separated node path.

Next, in step S4 in FIG. 4, the extraction unit 104 removes a non-applicable node from the separated node path.

The non-applicable node is a node that is not applicable to the first selection node, the second selection node, or the CO₂ emission amount node 201.

In the example of FIG. 7, “category 1”, “category 2”, “sheet metal G”, and “assembly G” are non-applicable nodes.

FIG. 8 illustrates a result of the process of step S4.

In FIG. 8, “category 1”, “category 2”, “sheet metal G”, and “assembly G” which are the non-applicable nodes have been deleted compared with FIG. 7.

Next, in step S5 in FIG. 4, the extraction unit 104 merges separated node paths where all nodes excluding the CO₂ emission amount node 201 are the same. Further, the extraction unit 104 calculates the CO₂ emission amount of the separated node path after merging.

In the example of FIG. 8, all of the nodes excluding the CO₂ emission amount nodes 201 are the same in the separated node path corresponding to the chain 3 and the separated node path corresponding to the chain 4 (“GHG”, “Scope3”, “manufacturing department” and “factory”).

Thus, the extraction unit 104 merges these two separated node paths. Further, the extraction unit 104 calculates a new CO₂ emission amount based on the CO₂ emission amount nodes 201 of these two separated node paths.

In the example of FIG. 8, the extraction unit 104 obtains “CO₂ emission amount 70(t)” by adding “CO₂ emission amount 30(t)” and “CO₂ emission amount 40(t)”.

FIG. 9 illustrates a result of the process of step S5.

Next, in step S6 in FIG. 4, the extraction unit 104 associates the CO₂ emission amount indicated in the CO₂ emission amount node 201 with a link between nodes.

FIG. 10 illustrates a result of the process of step S6.

In FIG. 10, a link between nodes of the first separated node path is associated with “10(t)” which is the CO₂ emission amount.

Further, a link between nodes of the second separated node path is associated with “20(t)” which is the CO₂ emission amount.

Further, a link between nodes of the third separated node path is associated with “70(t)” which is the CO₂ emission amount.

Next, in step S7 in FIG. 4, the extraction unit 104 commonizes duplicate portions of the separated node paths.

In the example of FIG. 10, “GHG” and “factory” are duplicated in three separated node paths. Further, “manufacturing department” is duplicated in the second separated node path and the third separated node path.

Thus, the extraction unit 104 commonizes “GHG” and “factory” in three separated node paths. Further, the extraction unit 104 commonizes “manufacturing department” in the second separated node path and the third separated node path.

At this time, the extraction unit 104 sets to the link between “manufacturing department” and “factory”, “90” which is the total value of “20” in the second separated node path and “70” in the third separated node path.

FIG. 11 illustrates a result of the process of step S7.

As described above, in FIG. 11, “GHG” and “factory” have been commonized, and “manufacturing department” has also been commonized. Moreover, “90” is set to the link between “manufacturing department” and “factory”.

A thickness of a line in the sankey diagram is determined according to a value set between nodes illustrated in FIG. 11.

Further, when the visualization information is generated in the bar graph, a length of a bar in the bar graph is determined according to a value set between nodes illustrated in FIG. 11.

Further, when the visualization information is generated in the pie chart, a size of a sector in the pie chart is determined according to a value set between nodes illustrated in FIG. 11.

### DESCRIPTION OF EFFECTS OF EMBODIMENT

In the present embodiment, a plurality of analysis axes are used, as analysis axes for analyzing the CO₂ emission amount. Thus, according to the present embodiment, it is possible to analyze the CO₂ emission amount based on various combinations of analysis axes, such as a combination of “GHG protocol” and “department”, a combination of “GHG protocol” and “facility”, and a combination of “energy source” and “department”. Moreover, the present embodiment visualizes an analysis result.

Thus, the data analyst can accurately estimate factors that contribute to the reduction of the CO₂ emission amount and can efficiently formulate measures to reduce the CO₂ emission amount.

### Embodiment 2

In the present embodiment, differences from Embodiment 1 will be mainly described.

Matters not described below are the same as those in Embodiment 1.

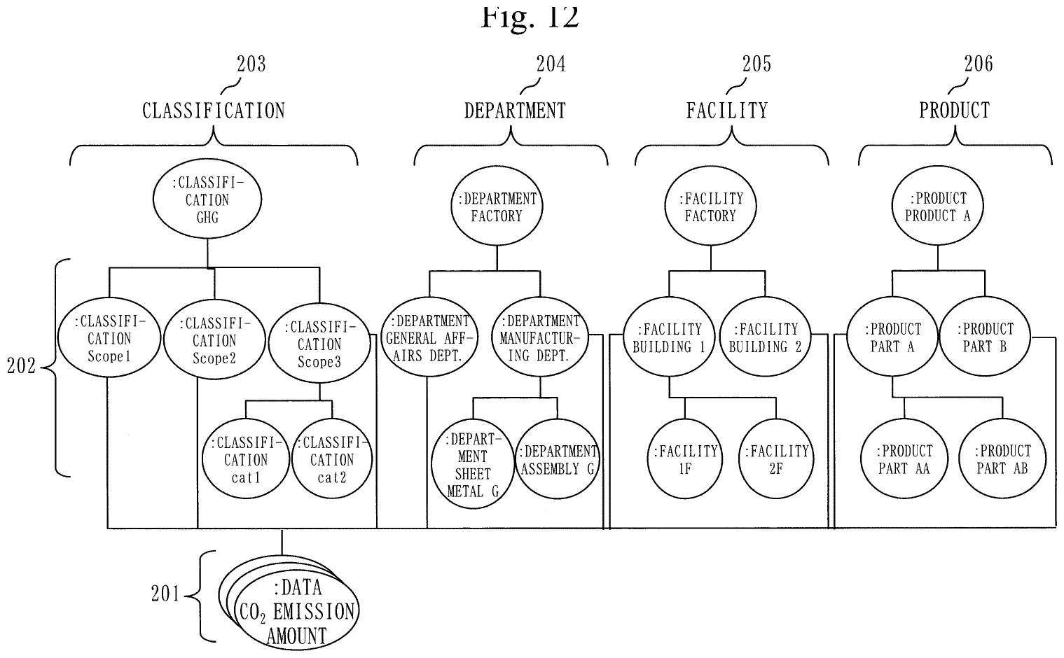

FIG. 12 illustrates an example of the hierarchical structure data 200 according to the present embodiment.

In the hierarchical structure data 200 (FIG. 2) of Embodiment 1, tag nodes at the lowest layer are basically connected to the CO₂ emission amount node 201. In the present embodiment, as illustrated in FIG. 12, tag nodes other than those at the lowest layer are connected to the CO₂ emission amount node 201.

Specifically, in FIG. 2, in the classification tag data 203, “category 1” and “category 2” are connected to the CO₂ emission amount node 201. On the other hand, in FIG. 12, “Scope3” which is a tag node located at a higher layer than “category 1” and “category 2”, is connected to the CO₂ emission amount node 201.

Further, in FIG. 2, in department tag data 204, “sheet metal G”, “CO₂ emission amount 10(t)” and “assembly G” are connected to the CO₂ emission amount node 201. On the other hand, in FIG. 12, “manufacturing department” which is a tag node located at a higher layer than “sheet metal G” and “assembly G”, is connected to the CO₂ emission amount node 201.

Further, in FIG. 2, in the facility tag data 205, “1F” and “2F” are connected to the CO₂ emission amount node 201. On the other hand, in FIG. 12, “building 1” which is a tag node located at a higher layer than “1F” and “2F”, is connected to the CO₂ emission amount node 201.

Further, in FIG. 2, in the facility tag data 205, “part AA” and “part AB” are connected to the CO₂ emission amount node 201. On the other hand, in FIG. 12, “part A” which is a tag node located at a higher layer than “part AA” and “part AB”, is connected to the CO₂ emission amount node 201.

In the present embodiment, in such a manner, the CO₂ emission amount node 201 is connected to tag nodes other than those at the lowest layer. Thus, the CO₂ emission amount is not managed for a node (hereinafter referred to as a subordinate node) located at a lower layer than a tag node connected to the CO₂ emission amount node 201. That is, in the department tag data 204, the CO₂ emission amount is managed for the entire “manufacturing department”, but the CO₂ emission amount is not managed for each of “sheet metal G” and “assembly G” which are subordinate nodes of “manufacturing department”, for example.

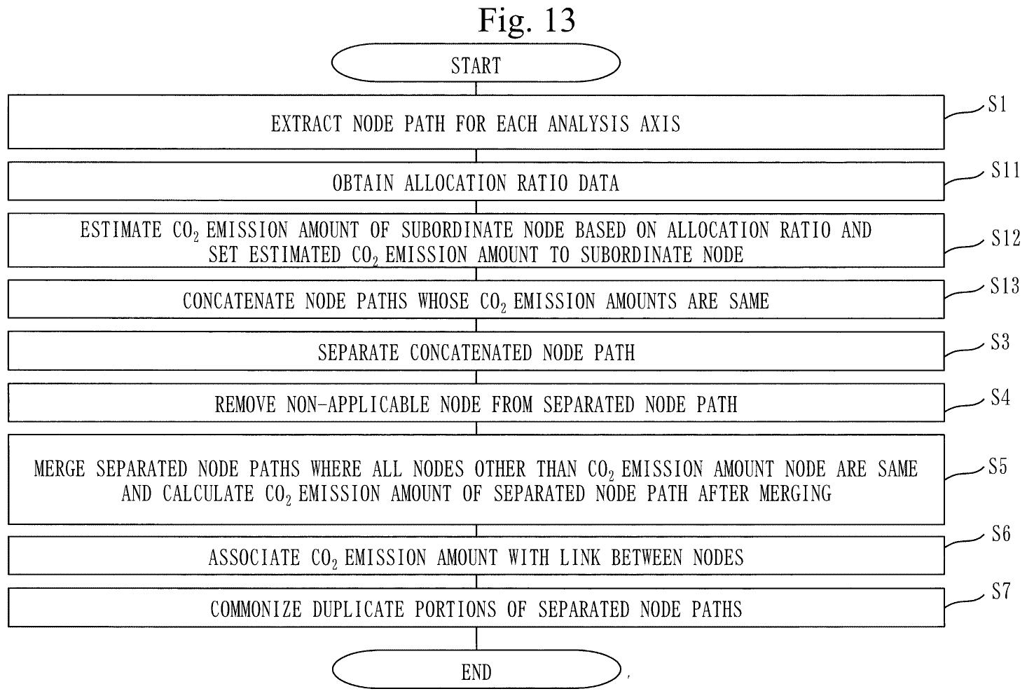

FIG. 13 illustrates an example of operation of the extraction unit 104 according to the present Embodiment.

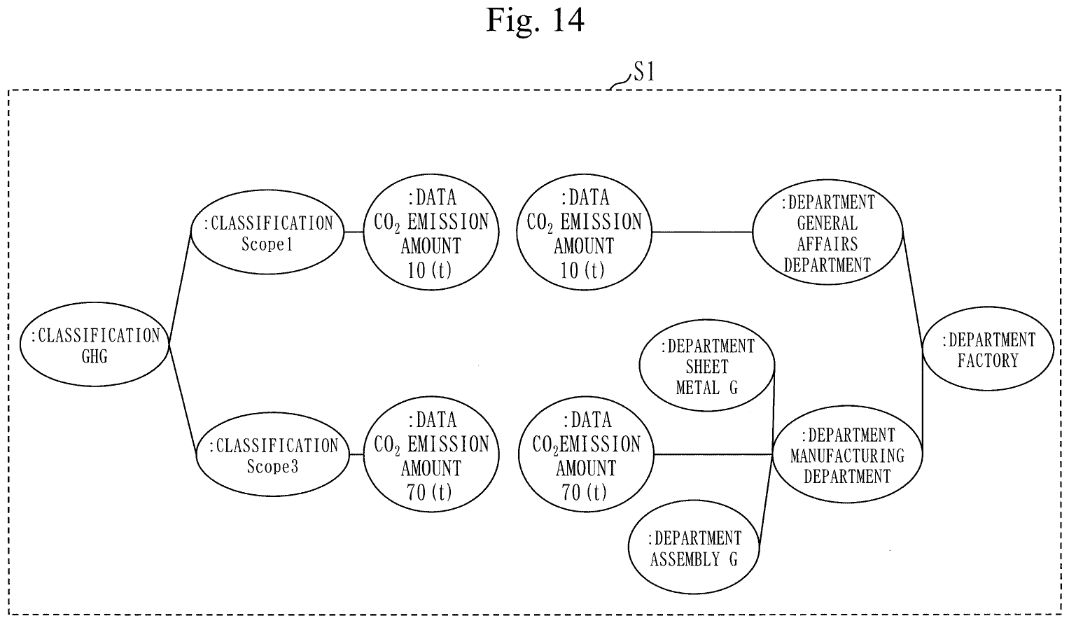

FIG. 14 illustrates a specific example of step S1 in FIG. 13.

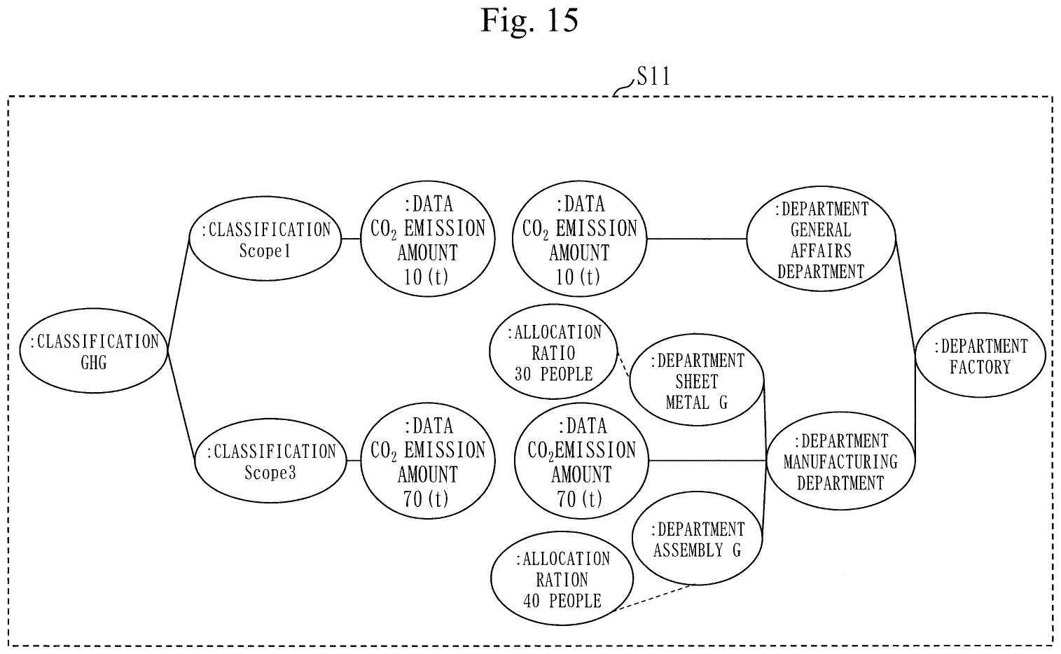

FIG. 15 illustrates a specific example of step S11 in FIG. 13.

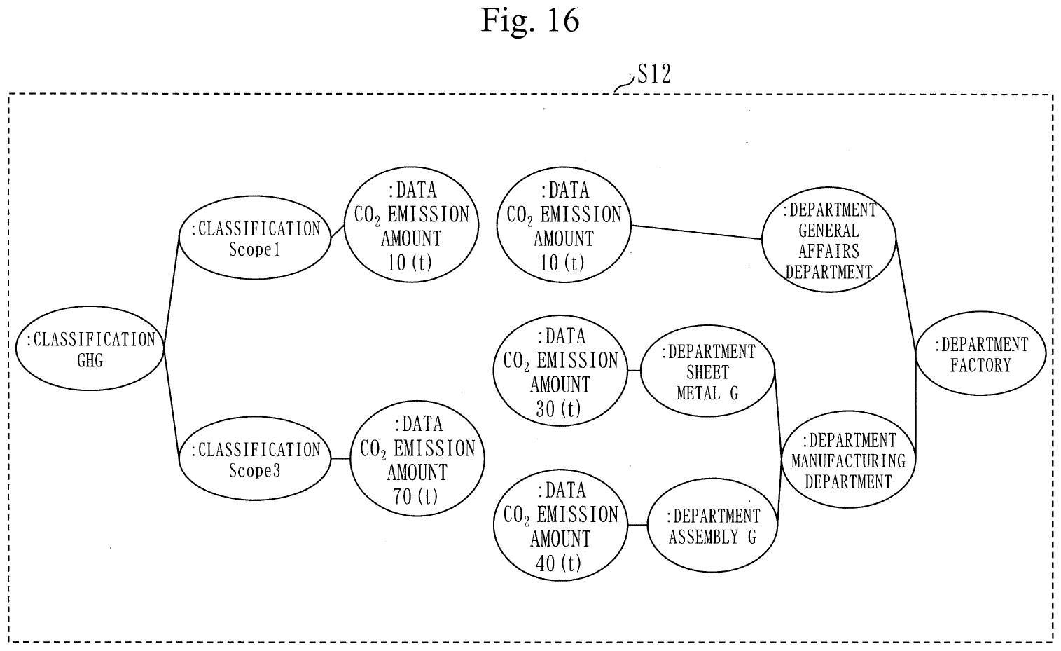

FIG. 16 illustrates a specific example of step S12 in FIG. 13.

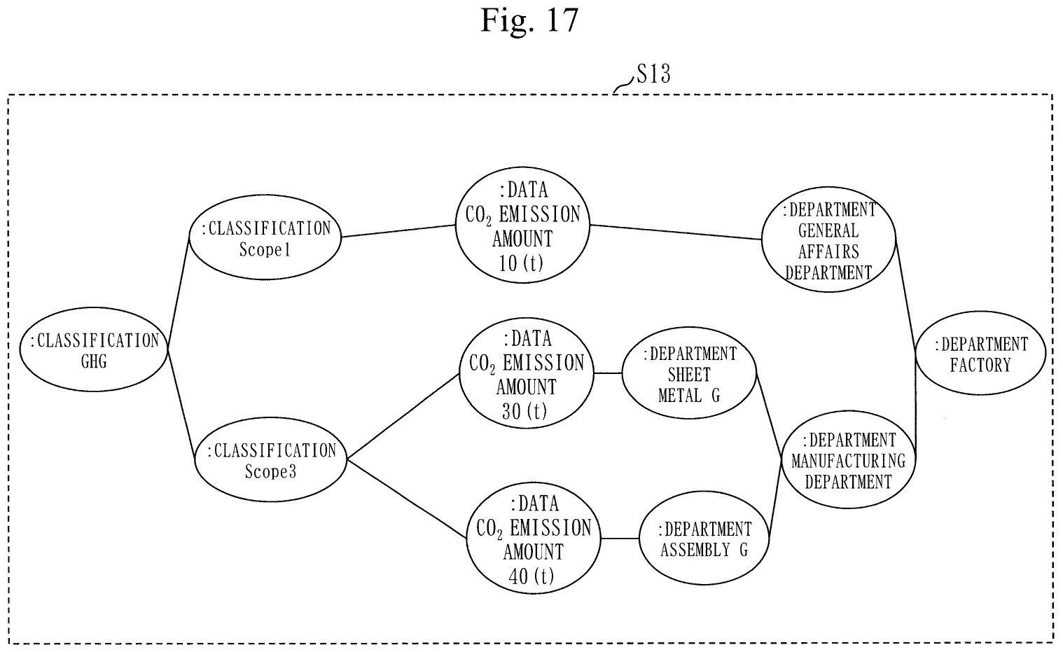

FIG. 17 illustrates a specific example of step S13 in FIG. 13.

In the following, the example of the operation of the extraction unit 104 according to the present embodiment will be described with reference to FIGS. 13 to 17.

Step S1 in FIG. 13 is the same as step S1 in FIG. 4.

In the present embodiment, “GHG”, “Scope1”, and “Scope3” are assumed to be selected as the first selection nodes in the analysis instruction for the first analysis axis, and “factory”, “general affairs department”, “sheet metal G”, and “assembly G” in the department tag data 204 are assumed to be selected as the second selection nodes for the second analysis axis.

FIG. 14 illustrates a result of the process of step S1 in this case.

In the present embodiment, the extraction unit 104 extracts “CO₂ emission amount 10(t)” which is the CO₂ emission amount node 201 to which “Scope1” which is the first connection node connects. Then, the extraction unit 104 extracts a node path that leads from “CO₂ emission amount 10(t)” to “GHG” which is the first selection node via “Scope1” which is the first connection node, as the first node path.

Further, the extraction unit 104 extracts “CO₂ emission amount 70(t)” which is the CO₂ emission amount node 201 to which “Scope3” which is the first connection node connects. Then, the extraction unit 104 extracts a node path that leads from “CO₂ emission amount 70(t)” to “GHG” which is the first selection node via “Scope3” which is the first connection node, as the first node path.

Furthermore, the extraction unit 104 extracts “CO₂ emission amount 10(t)” which is the CO₂ emission amount node 201 to which “general affairs department” which is the second connection node connects. Then, the extraction unit 104 extracts a node path that leads from “CO₂ emission amount 10(t)” to “factory” which is the second selection node via “general affairs department” which is the second connection node, as the second node path.

Furthermore, the extraction unit 104 extracts “CO₂ emission amount 70(t)” which is the CO₂ emission amount node 201 to which “manufacturing department” which is the second connection node connects. Then, the extraction unit 104 extracts a node path that leads from “CO₂ emission amount 70(t)” to “sheet metal G”, “assembly G”, and “factory” which are the second selection nodes via “manufacturing department” which is the second connection node, as the second node path.

In step S11 in FIG. 13, the extraction unit 104 obtains allocation ratio data. The allocation ratio data is data for estimating from the CO₂ emission amount of the CO₂ emission amount node 201 to which a superordinate node connects, the CO₂ emission amount of each of two or more subordinate nodes.

In the example of FIG. 14, the allocation ratio data is data for estimating the CO₂ emission amount of each of “sheet metal G” and “assembly G” from “CO₂ emission amount 70(t)” which is the CO₂ emission amount node 201 to which “manufacturing department” connects. In this case, the number of affiliated staff in a department can be used as the allocation ratio data, for example.

Further, a size (floor area, volume, or the like) of the facility can be used as the allocation ratio data for estimating the CO₂ emission amount of each of “1F” and “2F” in the facility tag data 205 in FIG. 2, for example.

Further, a cost ratio, a wright ratio, or the like of a part in the product can be used as the allocation ratio data for estimating the CO₂ emission amount of each of “part AA” and “part AB” in the product tag data 206 in FIG. 2, for example.

FIG. 15 illustrates a result of the process of step S11.

In FIG. 15, the number of affiliated staff in the department is used as the allocation ratio data. The number of affiliated staff of “sheet metal G” is 30 people. Further, the number of affiliated staff of “assembly G” is 40 people. The extraction unit 104 sets an allocation ratio “30 people” to “sheet metal G”. Further, the extraction unit 104 sets an allocation ratio “40 people” to “assembly G”.

In step S12 in FIG. 13, the extraction unit 104 estimates the CO₂ emission amount of the subordinate node based on an allocation ratio. Then, the extraction unit 104 sets to the subordinate node, the estimated CO₂ emission amount obtained from estimation.

In the example of FIG. 15, the extraction unit 104 allocates to “30:40”, “CO₂ emission amount 70(t)” to which “manufacturing department” connects, based on the allocation ratio. That is, the extraction unit 104 estimates “30(t)” as the CO₂ emission amount of “sheet metal G”, and estimates “40(t)” as the CO₂ emission amount of “assembly G”. Then, the extraction unit 104 sets “CO₂ emission amount 30(t)” to the tag node of “sheet metal G”, and sets “CO₂ emission amount 40(t)” to the tag node of “assembly G”.

FIG. 16 illustrates a result of the process of step S12.

In step S13 in FIG. 13, the extraction unit 104 concatenates the first node path and the second node path whose CO₂ emission amount nodes 201 are the same. In step S13, the extraction unit 104 also concatenates the first node path and the second node path when the CO₂ emission amounts and the total value of estimated CO₂ emission amounts are the same.

Specifically, in FIG. 16, “CO₂ emissions of 70 (t)” that connects to “Scope3” is the same as the total value of “CO₂ emissions of 30 (t)” that connects to “sheet metal G” and “CO₂ emissions of 40 (t)” that connects to “assembly G”. Thus, the extraction unit 104 concatenates the node path of “Scope3” to the node paths of “sheet metal G” and the node path of “assembly G”.

FIG. 17 illustrates a result of the process of step S13.

Steps S3 to S7 in FIG. 13 are the same as those described in Embodiment 1. Thus, the description of steps S3 to S7 is omitted.

In such a manner, even when the CO₂ emission amount node 201 is connected to a tag node at a layer other than the lowest layer, it is possible to analyze the CO₂ emission amount through various combinations of analysis axes. Further, even when the CO₂ emission amount node 201 is connected to a tag node at a layer other than the lowest layer, an analysis result can be visualized.

Embodiments 1 and 2 have been described above and these two embodiments may be implemented in combination.

Alternatively, one of these two embodiments may be implemented partially.

Alternatively, these two embodiments may be implemented partially in combination.

Further, the configurations and procedures described in these two embodiments may be modified as necessary.

### ***Supplementary Explanation of Hardware Configuration***

Finally, a supplementary description of the hardware configuration of the emission amount management apparatus 100 will be given.

The processor 901 illustrated in FIG. 18 is an Integrated Circuit (IC) that performs processing.

The processor 901 is a Central Processing Unit (CPU), a (Digital Signal Processor (DSP), or the like.

The main memory device 902 illustrated in FIG. 18 is a Random Access Memory (RAM).

The auxiliary storage device 903 illustrated in FIG. 18 is a Read Only Memory (ROM), a flash memory, a Hard Disk Drive (HDD), or the like.

The communication device 904 illustrated in FIG. 18 is an electronic circuit that executes a communication process for data.

The communication device 904 is, for example, a communication chip or a Network Interface Card (NIC).

Further, the auxiliary storage device 903 also stores an Operating System (OS).

Then, at least a part of the OS is executed by the processor 901.

While executing at least the part of the OS, the processor 901 executes programs that implement the functions of the data management unit 101, the instruction acquisition unit 103, the extraction unit 104, and the visualization unit 105.

By the processor 901 executing the OS, task management, memory management, file management, communication control, and the like are performed.

Further, at least one of information, data, a signal value, and a variable value that indicate results of processes of the data management unit 101, the instruction acquisition unit 103, the extraction unit 104, and the visualization unit 105, is stored in at least one of the main memory device 902, the auxiliary storage device 903, and a register and a cache memory in the processor 901

Further, the programs that implement the functions of the data management unit 101, the instruction acquisition unit 103, the extraction unit 104, and the visualization unit 105 may be stored in a portable recording medium such as a magnetic disk, a flexible disk, an optical disc, a compact disc, a Blu-ray (registered trademark) disc, or a DVD. Then, the portable recording medium storing the programs that implement the functions of the data management unit 101, the instruction acquisition unit 103, the extraction unit 104, and the visualization unit 105 may be distributed.

Further, the “unit” of at least one of the data management unit 101, the instruction acquisition unit 103, the extraction unit 104 and the visualization unit 105 may be read as a “circuit”, “step”, “procedure”, “process”, or “circuitry”.

Further, the emission amount management apparatus 100 may be implemented by a processing circuit. The processing circuit is, for example, a logic Integrated Circuit (IC), a Gate Array (GA), an Application Specific Integrated Circuit (ASIC), or a Field-Programmable Gate Array (FPGA).

In this case, each of the data management unit 101, the instruction acquisition unit 103, the extraction unit 104 and the visualization unit 105 is implemented as a part of the processing circuit.

In the present description, a superordinate concept of the processor and the processing circuit is referred to as “processing circuitry”.

That is, each of the processor and the processing circuit is a specific example of the “processing circuitry”.

### REFERENCE SIGNS LIST

100: emission amount management apparatus; 101: data management unit; 102: memory unit; 103: instruction acquisition unit; 104: extraction unit; 105: visualization unit; 200: hierarchical structure data; 201: CO₂ emission amount node; 202: tag data; 203: classification tag data; 204: department tag data; 205: facility tag data; 206: product tag data; 300: visualization information; 901: processor; 902: main memory device; 903: auxiliary storage device; 904: communication device; 905: input/output device.

1. A data processing apparatus comprising:
processing circuitry:
to manage a hierarchical structure data that includes: a first hierarchical structure in which a plurality of first nodes are hierarchized, the first hierarchical structure corresponding to a first analysis axis which is an analysis axis of a greenhouse gas emission amount; a second hierarchical structure in which a plurality of second nodes are hierarchized, the second hierarchical structure corresponding to a second analysis axis which is an analysis axis of the greenhouse gas emission amount and which is different from the first analysis axis; and a plurality of emission amount nodes which are nodes of the greenhouse gas emission amount, wherein the plurality of first nodes include two or more first connection nodes that connect to one of the emission amount nodes, and the plurality of second nodes include two or more second connection nodes that connect to one of the emission amount nodes; and
when one of the first nodes is selected as a first selection node and one of the second nodes is selected as a second selection node, wherein,
after extracting for each first connection node, a first node path which is a chain of nodes that leads to the first selection node via the first connection node from the emission amount node to which the first connection node connects, and after extracting for each second connection node, a second node path which is a chain of nodes that leads to the second selection node via the second connection node from the emission amount node to which the second connection node connects,
when two or more first node paths and two or more second node paths are extracted, when the greenhouse gas emission amounts of two or more emission amount nodes to which two or more first connection nodes included in the two or more extracted first node paths connect are mutually different, when the number of second connection nodes included in the two or more extracted second node paths is the same as the number of the two or more first connection nodes, and when the greenhouse gas emission amounts are the same between two or more emission amount nodes to which two or more second connection nodes connect and the two or more emission amount nodes to which the two or more first connection nodes connect,
to concatenate the two or more first node paths and the two or more second node paths by concatenating the first node path and the second node path in which the first connection node and the second connection node connect to emission amount nodes each having the same greenhouse gas emission amount.

2. The data processing apparatus according to claim 1, wherein
the processing circuitry manages the two or more first node paths in a tree structure where duplicate portions are commonized,
manages the two or more second node paths in a tree structure where duplicate portions are commonized, and
concatenates the first node path and the second node path in which the first connection node and the second connection node connect to emission amount nodes each having the same greenhouse gas emission amount, among the two or more first node paths managed in the tree structure and the two or more second node paths managed in the tree structure.

3. The data processing apparatus according to claim 2, wherein
the processing circuitry concatenates the first node path and the second node path in which the first connection node and the second connection node connect to emission amount nodes each having the same greenhouse gas emission amount, among the two or more first node paths managed in the tree structure and the two or more second node paths managed in the tree structure, and after a concatenated node path which is a node path after concatenation includes a plurality of chains of nodes that lead from the first selection node to the second selection node via the first connection node, the emission amount node, and the second connection node,
separates the concatenated node path into a plurality of node paths so that each of the plurality of chains of nodes included in the concatenated node path is included in any one of the plurality of node paths after separation, and the chains of nodes included in each of the plurality of node paths after separation are mutually different.

4. The data processing apparatus according to claim 3, wherein
the processing circuitry removes from each of a plurality of separated node paths which are the plurality of nodes paths obtained by separation of the concatenated node path, a non-applicable node that is not applicable to any one of the first selection node, the second selection node, and the emission amount node, and
merges two or more separated node paths where the first selection node and the second selection node are the same among the plurality of separated node paths after the non-applicable node has been removed.

5. The data processing apparatus according to claim 4, wherein
the processing circuitry visualizes the greenhouse gas emission amount based on the first analysis axis and the second analysis axis, using the separated node path after merging.

6. The data processing apparatus according to claim 1, wherein
when each of two or more subordinate nodes located in the lower layer of one of second connection nodes is selected as the second selection node,
the processing circuitry allocates to the two or more subordinate nodes selected as the second selection node, the greenhouse gas emission amount of the emission amount node to which the second connection node connects.

7. The data processing apparatus according to claim 1, wherein
the processing circuitry manages hierarchical structure data that includes a plurality of first hierarchical structures corresponding to a plurality of first analysis axes, each of the plurality of first hierarchical structures including two or more of the first connection nodes, and
when one of the plurality of first hierarchical structures is selected as a first selection hierarchical structure and one of first nodes of the first selection hierarchical structure is selected as the first selection node, the processing circuitry extracts the first node path for each first connection node of the first selection hierarchical structure.

8. The data processing apparatus according to claim 1, wherein
the processing circuitry manages hierarchical structure data that includes a plurality of second hierarchical structures corresponding to a plurality of second analysis axes, each of the plurality of second hierarchical structures including two or more of the second connection nodes, and
when one of the plurality of second hierarchical structures is selected as a second selection hierarchical structure and one of second nodes of the second selection hierarchical structure is selected as the second selection node, the processing circuitry extracts the second node path for each second connection node of the second selection hierarchical structure.

9. A data processing method comprising:
managing a hierarchical structure data that includes: a first hierarchical structure in which a plurality of first nodes are hierarchized, the first hierarchical structure corresponding to a first analysis axis which is an analysis axis of a greenhouse gas emission amount; a second hierarchical structure in which a plurality of second nodes are hierarchized, the second hierarchical structure corresponding to a second analysis axis which is an analysis axis of the greenhouse gas emission amount and which is different from the first analysis axis; and a plurality of emission amount nodes which are nodes of the greenhouse gas emission amount, wherein the plurality of first nodes include two or more first connection nodes that connect to one of the emission amount nodes, and the plurality of second nodes include two or more second connection nodes that connect to one of the emission amount nodes; and
when one of the first nodes is selected as a first selection node and one of the second nodes is selected as a second selection node, wherein,
after extracting for each first connection node, a first node path which is a chain of nodes that leads to the first selection node via the first connection node from the emission amount node to which the first connection node connects, and after extracting for each second connection node, a second node path which is a chain of nodes that leads to the second selection node via the second connection node from the emission amount node to which the second connection node connects,
when two or more first node paths and two or more second node paths are extracted, when the greenhouse gas emission amounts of two or more emission amount nodes to which two or more first connection nodes included in the two or more extracted first node paths connect are mutually different, when the number of second connection nodes included in the two or more extracted second node paths is the same as the number of the two or more first connection nodes, and when the greenhouse gas emission amounts are the same between two or more emission amount nodes to which two or more second connection nodes connect and the two or more emission amount nodes to which the two or more first connection nodes connect,
concatenating the two or more first node paths and the two or more second node paths by concatenating the first node path and the second node path in which the first connection node and the second connection node connect to emission amount nodes each having the same greenhouse gas emission amount.

10. A non-transitory computer readable medium storing a data processing program for causing a computer to execute:
a data management process to manage a hierarchical structure data that includes: a first hierarchical structure in which a plurality of first nodes are hierarchized, the first hierarchical structure corresponding to a first analysis axis which is an analysis axis of a greenhouse gas emission amount; a second hierarchical structure in which a plurality of second nodes are hierarchized, the second hierarchical structure corresponding to a second analysis axis which is an analysis axis of the greenhouse gas emission amount and which is different from the first analysis axis; and a plurality of emission amount nodes which are nodes of the greenhouse gas emission amount, wherein the plurality of first nodes include two or more first connection nodes that connect to one of the emission amount nodes, and the plurality of second nodes include two or more second connection nodes that connect to one of the emission amount nodes; and
an extraction process,
when one of the first nodes is selected as a first selection node and one of the second nodes is selected as a second selection node, wherein,
after extracting for each first connection node, a first node path which is a chain of nodes that leads to the first selection node via the first connection node from the emission amount node to which the first connection node connects, and after extracting for each second connection node, a second node path which is a chain of nodes that leads to the second selection node via the second connection node from the emission amount node to which the second connection node connects,
when two or more first node paths and two or more second node paths are extracted, when the greenhouse gas emission amounts of two or more emission amount nodes to which two or more first connection nodes included in the two or more extracted first node paths connect are mutually different, when the number of second connection nodes included in the two or more extracted second node paths is the same as the number of the two or more first connection nodes, and when the greenhouse gas emission amounts are the same between two or more emission amount nodes to which two or more second connection nodes connect and the two or more emission amount nodes to which the two or more first connection nodes connect,
to concatenate the two or more first node paths and the two or more second node paths by concatenating the first node path and the second node path in which the first connection node and the second connection node connect to emission amount nodes each having the same greenhouse gas emission amount.
